(19) United States
(12) Patent Application Publication
(10) Pub. No.: US 2020/0026833 A1
(43) Pub. Date: Jan. 23, 2020

(54) BIOMETRICS AUTHENTICATION DEVICE AND METHOD

(71) Applicant: GIN-CHUNG WANG, LINCOLNSHIRE, IL (US)

(72) Inventor: GIN-CHUNG WANG, LINCOLNSHIRE, IL (US)

(21) Appl. No.: 16/042,325

(22) Filed: Jul. 23, 2018

(51) Int. Cl. G06F 21/32; G06K 9/00

(52) U.S. Cl. CPC G06F 21/32; G06K 9/00906; G06K 9/00892; G06K 2009/00939; G06K 9/00288; G06K 9/00087; G06K 9/00536

(57) ABSTRACT

A biometrics authentication device has an object scanner, an object authentication device, a pulse waveform generation device, a pulse waveform authentication device and a determination device. The object scanner receives at least one of object images of a living being. The object authentication device performs an object authentication according to the at least one object image. The pulse waveform generation device receives the object images to generate a pulse waveform of the living being according to the object images and timestamps at which the object images are captured. The pulse waveform authentication device performs a pulse waveform authentication device according to the pulse waveform. The determination device determines a biometrics authentication result according to results of the object waveform authentication and the pulse waveform authentication.

### TECHNICAL FIELD

The present disclosure relates to an authentication technology, in particular to, a biometrics authentication device and a biometrics authentication method, which utilize images captured by an image capturing device to perform both of an object authentication and a pulse waveform authentication.

### RELATED ART

Object images of living beings can be used for identifications of the living beings. For example, different people have different faces or fingerprints, and images of the faces or fingerprints of the people can be used to recognize the identifications of the people. However, current fingerprint (or face) scanning devices only acquire fingerprint images (or face images) and are prone to be tricked or hacked with a printed fingerprint image (or a printed face image).

To prevent from tricking or hacking, other sensors or authentication devices may be added to the current fingerprint (or face) scanning devices. For example, to make sure that the acquired fingerprint images (or face images) are real but not printed, temperature sensors (such as, infrared light sensors) may be added and used to detect finger (or face) temperatures of the people, or alternatively, voice acquiring devices may be added and used to identify the people according to acquired voices. However, the above manners increase manufacturing costs of the fingerprint (or face) scanning devices. Further, there are still other manners for tricking or hacking the fingerprint (or face) scanning devices adding the sensors or biometrics authentication devices, which causes security issues.

### SUMMARY

An objective of the present disclosure is to provide a biometrics authentication device and a biometrics authentication method, which utilize an object scanning device (such as, fingerprint or face scanning device) for performing both of an object authentication and a pulse waveform authentication, without adding any new sensor or authentication device, thus increasing a security level and decreasing a manufacturing cost.

Another objective of the present disclosure is to provide a biometrics authentication device and a biometrics authentication method, which generate a pulse waveform of a living being according to object images acquired by an object scanning device, without adding any new sensor or authentication device, thus increasing an applicability.

Another objective of the present disclosure is to provide a biometrics authentication device and a biometrics authentication method, which determine a biometrics authentication result according to an object authentication result and a pulse waveform authentication result, thus increasing a biometrics authentication accuracy.

To achieve at least one of the above objectives, the present disclosure provides a biometrics authentication device, comprising: an object scanner, receiving at least one of object images of a living being; an object authentication device, electrically connected to the object scanner, performing an object authentication according to the at least one object image; a pulse waveform generation device, receiving the object images to generate a pulse waveform of the living being according to the object images and timestamps at which the object images are captured; a pulse waveform authentication device, electrically connected to the pulse waveform generation device, performing a pulse waveform authentication device according to the pulse waveform; and a determination device, electrically connected to the object authentication device and the pulse waveform authentication device, determining a biometrics authentication result according to results of the object waveform authentication and the pulse waveform authentication.

In an embodiment, the biometrics authentication device further comprises: an image capturing device, electrically connected to the object scanner and the pulse waveform generation device, capturing the object images of the living being at the timestamps, respectively.

In an embodiment, the biometrics authentication device further comprises: a storage device, electrically connected to the pulse waveform authentication device, storing the pulse waveform of the living being, wherein the stored pulse waveform of the living being is utilized in a wellness analysis of the living being.

In an embodiment, the object scanner extracts an object data from the at least one object image, and the object data relates to an object characteristic data in at least one of a spatial domain and a frequency domain.

In an embodiment, the object data is compared with at least one reference object data to perform the object authentication, and the reference object data corresponds to a type of the object data and relates to an object characteristic data in at least one of the spatial domain and the frequency domain.

In an embodiment, the pulse waveform generation device obtains a summate value of values of selected pixels in each of the object images and establishes the pulse waveform according to the summated values of the object images and the timestamps.

In an embodiment, the selected pixels in each of the object images are determined in a way to maximize a signal-to-noise ratio (SNR) of the pulse waveform.

In an embodiment, a pulse waveform characteristic data of the pulse waveform in at least one of a time domain and a frequency domain is compared with at least one reference pulse waveform characteristic data of at least one reference pulse waveform in at least one of the time domain and the frequency domain, to perform the pulse waveform authentication.

In an embodiment, the results of the object waveform authentication and the pulse waveform authentication are input to a logic or weighting calculation to determine the biometrics result.

In an embodiment, by a firmware of an object scanning device, a processing unit of the scanning device is configured to the object scanner, the object authentication device, the pulse waveform generation device, the pulse waveform authentication device and the determination device

To achieve at least one of the above objectives, the present disclosure provides a biometrics authentication method, comprising: receiving at least one of object images of a living being; performing an object authentication according to the at least one object image; receiving the object images to generate a pulse waveform of the living being according to the object images and timestamps at which the object images are captured; performing a pulse waveform authentication device according to the pulse waveform; and determining a biometrics authentication result according to results of the object waveform authentication and the pulse waveform authentication.

In an embodiment, the biometrics authentication method is implemented by a computing device by executing a software comprising codes.

To sum up, the biometrics authentication device and the biometrics authentication method provided by the present disclosure have benefits of increasing the security level, the applicability and biometric authentication accuracy, and further have the advantages of decreasing manufacturing cost. The biometrics authentication device and the biometrics authentication method can be implemented by a firmware, a hardware, a software or combination of the above, and can be products on the market.

### BRIEF DESCRIPTION OF THE DRAWINGS

In order that the present disclosure may be better understood and readily carried into effect, certain embodiments of the present disclosure will now be described with reference to the accompanying drawings, wherein:

FIG. 1 is a block diagram of a biometrics authentication device according to an embodiment of the present disclosure;

FIG. 2 is a block diagram of a biometrics authentication device according to another embodiment of the present disclosure;

FIG. 3 is schematic diagram of acquiring a pule waveform of a living being based on object images of the living being according to an embodiment of the present disclosure; and

FIG. 4 is a flow chart of a biometrics authentication method according to an embodiment of the present disclosure.

### DETAILED DESCRIPTION OF THE PREFERRED EMBODIMENTS

To make it easier for the examiner to understand the objects, characteristics and effects of this present disclosure, embodiments together with the attached drawings for the detailed description of the present disclosure are provided.

Embodiments of the present disclosure provide a biometrics authentication device and a biometrics authentication method. The biometrics authentication device and method utilize an object scanning device (such as, fingerprint or face scanning device) to acquire object images of a living being (such as, fingerprint images or face images of a human). Then, the biometrics authentication device and method extract an object data from at least one of the object images, and then perform an object authentication for comparing the object data with at least one reference object data.

Further, the biometrics authentication device and method generate a pulse waveform of the living being according to the object images of the living being, and then perform a pulse waveform authentication for comparing the pulse waveform of the living being with at least one reference pulse waveform. Next, the biometrics authentication device and method determine a biometrics authentication result according to an object authentication result and a pulse waveform authentication result, so as to identify the living being.

It is noted that the object data can be an object characteristic data of the object in at least one of a spatial domain and a frequency domain, and the at least one reference object data can be at least one reference object characteristic in the at least one of the spatial and frequency domains. A pulse waveform characteristic data of the pulse waveform in at least one of a time domain and a frequency domain is compared with a reference pulse waveform characteristic data of the least one reference pulse waveform in at least one of the time and frequency domains, so as to compare the pulse waveform of the living being with the at least one reference pulse waveform. Further, the object authentication result and the pulse waveform authentication result are input to a logic calculation or a weighting calculation to determine the biometrics authentication result.

Conceptual aspects of the present disclosure have been disclosed by the above descriptions, and details of the present disclosure will be illustrated as follows.

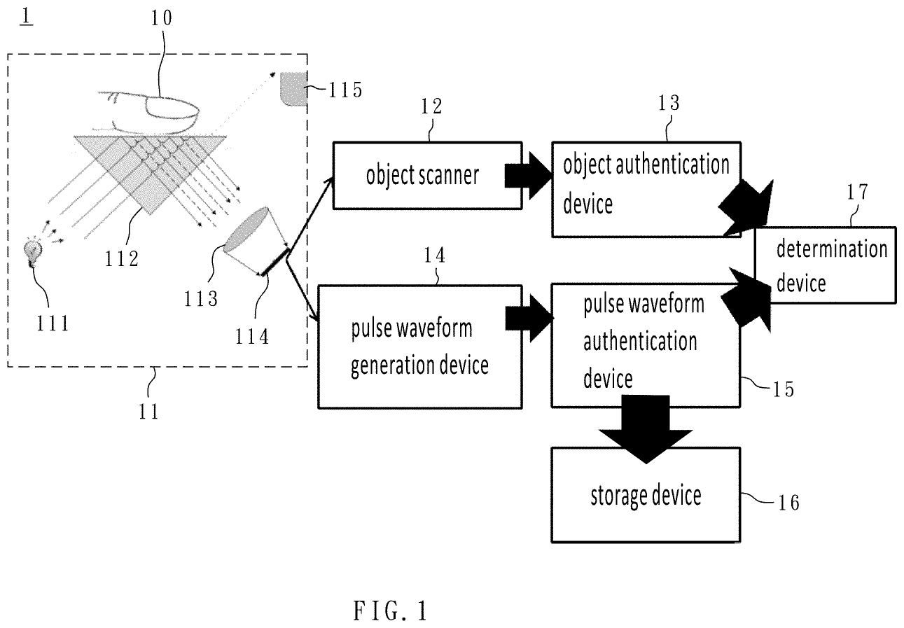

Referring to FIG. 1, FIG. 1 is a block diagram of a biometrics authentication device according to an embodiment of the present disclosure. The biometrics authentication device 1 comprises an image capturing device 11, an object scanner 12, an object authentication device 13, a pulse waveform generation device 14, a pulse waveform authentication device 15, a storage device 16 and a determination device 17.

The image capturing device 10 is electrically connected to the object scanner 12 and the pulse waveform generation circuit 14. The object authentication device 13 is electrically connected to the object scanner 12 and the determination device 17. The pulse waveform authentication device 15 is electrically connected to the pulse waveform generation device 14, the determination device 17 and the storage device 16.

The image capturing device 11 is used to capture object images of an object (such as, fingerprint images of a finger 10 of a human, or face images of a face of the human), and the captured object images are sent to the object scanner 12 and the pulse waveform generation device 14.

The image capturing device 11 can comprise a light source 111 (such as, a light emission diode (LED) or a light amplification by stimulated emission of radiation (LASER) source), a prism 112, lens 113, a photodetection device 114 (such as, a charge-coupled device (CCD) or complementary Metal-Oxide-Semiconductor (CMOS) image sensor) and a light blocker 115. The light source 111 emits light beams to the prism 112, and the finger 10 disposed on the prism 112 reflect the partial light beams. The reflected partial light beams are collected by lens 113, and the lens 113 focuses the reflected partial light beams on the photodetection device 114. The photodetection device 114 is used to generate the object image according to the reflected partial light beams. The light blocker 115 is used to prevent the non-reflected light beams from propagating outside, and the light blocker 115 can be a black colored light absorber. It is noted that the above implementation of the image capturing device 11 is not intended to limit the present disclosure.

Optionally, the image capturing device 11 can be removed from the biometrics authentication device 1 and replaced by an external image capturing device. That is, the image capturing device 11 is not an essential component of the biometrics authentication device 1, and the marketed product can be the biometrics authentication device 1 without the image capturing device 11. Optionally, the storage device 16 can be removed from the biometrics authentication device 1 or replaced by an external storage device. That is, the storage device 16 is not an essential component of the biometrics authentication device 1, and the marketed product can be the biometrics authentication device 1 without the storage device 16.

The object scanner 12 receives at least one of the object images and extracts an object data from the at least one object image. The object image has an object portion and a background portion therein, and the object portion of the object image is extracted. Then, the object data of the extracted object portion is obtained. The object data of the extracted object portion can be an object raw data in a spatial domain, an object characteristic data in the spatial domain, an object characteristic data in a frequency domain, or any combination of the above.

Further, to increase an object authentication accuracy, preferably, the object scanner 12 receives the object images and extracts an object data from the object images, wherein the object data can be an average object raw data of the object images in the spatial domain, an average object characteristic data of the object images in the spatial domain, an average object characteristic data of the object images in the frequency domain, or any combination of the above.

The object authentication device 13 receives the object data from the object scanner 12 and compares the object data with at least one reference object data for performing an object authentication. Depending on the type of the object data, the reference object data can be a reference object raw data in a spatial domain, a reference object characteristic data in the spatial domain, the reference object characteristic data in the frequency domain, or any combination of the above.

Each reference object data corresponds to a living being, and the object data can be compared with multiple reference object data, wherein the multiple reference object data are pre-stored in the object authentication device 13 or fetched from a cloud server which stores the multiple reference object data. Accordingly, the object authentication device 13 identifies the living being according to the at least one captured object image, and outputs an objection authentication result to the determination device 17.

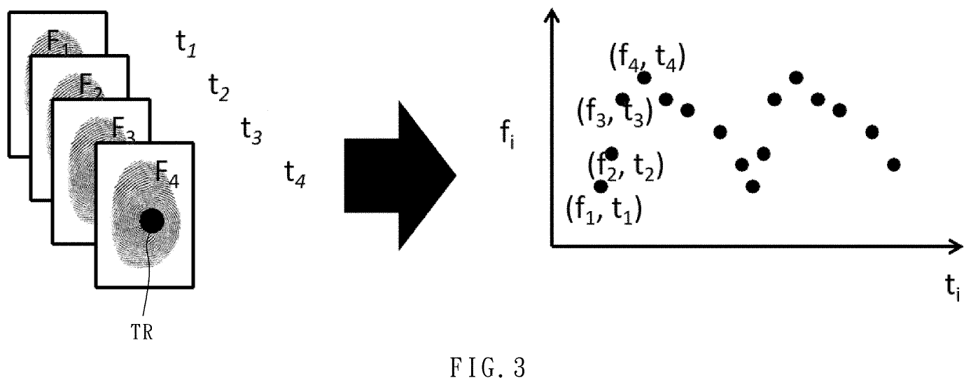

The pulse waveform generation device 14 receives the object images and generate a pulse waveform of the living being according to the object images. Specifically, further referring to FIG. 3, the object images F1 through F4 are captured at timestamps t1 through t4, and values of selected pixels within a target region TR of each object images F1 through F4 are summated, wherein the target region TR is defined by a user or in default. The summated value of the object image is denoted as fi=/ΣPni, wherein Pni is the value of selected pixel within the target region TR of the object image Fi, and i is an integer. The pulse waveform generation device 14 establishes the pulse waveform (for example, photoplethysmogram (PPG)) of the living being according to the summated values fi=/ΣPni of the object images Fi and the timestamps ti, as shown in FIG. 3. Preferably, the target region TR (i.e. the pixels to be selected) can be determined in a way to maximize a signal-to-noise ratio (SNR) of the pulse waveform (with the largest change synchronized with the heart beats).

The pulse waveform authentication device 15 receives the established pulse waveform from the pulse waveform generation device 14 and compares the established pulse waveform with at least one reference pulse waveform. It is noted that a pulse waveform characteristic data of the pulse waveform in at least one of a time domain and the frequency domain is compared with a reference pulse waveform characteristic data of the least one reference pulse waveform in at least one of the time and frequency domains, so as to compare the pulse waveform of the living being with the at least one reference pulse waveform.

Each reference pulse waveform data corresponds to a living being, and the pulse waveform can be compared with multiple reference pulse waveforms, wherein the multiple reference pulse waveforms are pre-stored in the pulse waveform authentication device 15 or fetched from a cloud server which stores the multiple reference pulse waveforms. Accordingly, the pulse waveform authentication device 15 identifies the living being according to the pulse waveform, and outputs a pulse waveform authentication result to the determination device 17.

The storage device 16 can be any type of storage equipment, such as, a solid-state drive (SSD), hard disk drive (HDD), universal serial bus (USB) flash or memory card. The storage device 16 is used to store the pulse waveform of the living being, such that a wellness analysis of the living being can be done according to the stored pulse waveforms, which increase an applicability of the biometrics authentication device 1. In another embodiment, the storage device 16 can further store multiple reference pulse waveforms for providing the multiple reference pulse waveforms to the pulse waveform authentication device 15. In another embodiment, the storage device may also store the multiple reference object data and further be electrically connected to the object authentication device 13 for providing the multiple reference object data to the object authentication device 13.

The determination device 17 receives the object authentication result and the pulse waveform authentication result, and then determines a biometrics authentication result according to the object authentication result and the pulse waveform authentication result. It is noted that, the object authentication result and the pulse waveform authentication result are input to a logic or weighting calculation to generate the biometric authentication result. For, example, the logic calculation can be “AND” or “OR” calculation.

It is noted that the biometrics authentication device 1 is implemented by an object scanning device (such as, fingerprint or face scanning device). The object scanning device comprises an image capturing device 11 and a processing unit (such as, processor or microcontroller (MCU)), and a firmware of the processing unit can be modified to configure object scanning device to comprise the object scanner 12, the object authentication device 13, the object authentication device 13, the pulse waveform generation device 14, the pulse waveform authentication device 15 and the determination device 17. The object scanning device may further comprise the storage device 16. Moreover, in another embodiment, the biometrics authentication device 1 can be implemented by hardware circuits, for example, application-specific integrated circuit (ASIC) or field programmable gate array (FPGA).

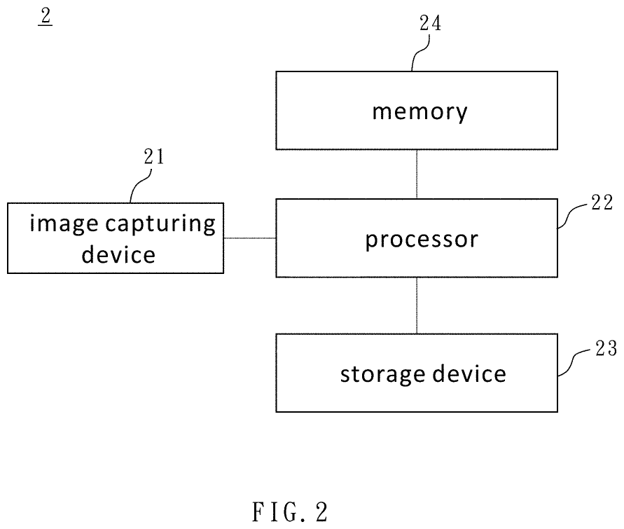

Referring to FIG. 2, FIG. 2 is a block diagram of a biometrics authentication device according to another embodiment of the present disclosure. The biometrics authentication device 2 is mainly implemented by a software and a computing device. The computing device comprises a processor 22, a memory 24 and a storage device 23, wherein the processor 22 is electrically an image capturing device 21, the memory 24 and the storage device 23.

Functions of the image capturing device 21 are the same as those of the image capturing device 11 in FIG. 1, thus omitting redundant descriptions. The software is stored in the storage device 23, and the software comprises codes which can be read and executed by the processor 22, thus configuring the biometrics authentication device 2 to have function modules of the object scanner 12, the object authentication device 13, the object authentication device 13, the pulse waveform generation device 14, the pulse waveform authentication device 15 and the determination device 17 in FIG. 1. Other functions of the storage device 23 can be the same as those of the storage device 16 in FIG. 1, thus omitting redundant descriptions.

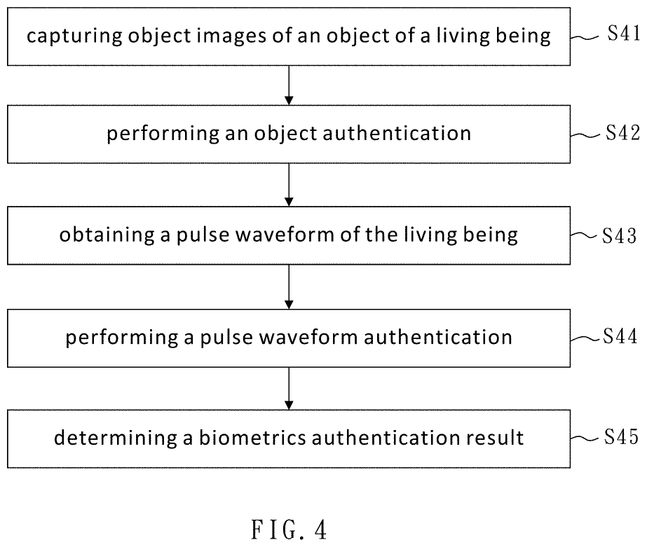

As mentioned above, the software has the codes for implementing a biometrics authentication method, and steps of the biometrics authentication method are illustrated as follows. Referring FIG. 4, FIG. 4 is a flow chart of a biometrics authentication method according to an embodiment of the present disclosure. At step S41, object images of an object of a living being are captured. Next, at step S42, an object authentication is performed according to at least one object image. Then, at step S43, a pulse waveform of the living being is obtained according to the object images and timestamps of the object images. Next, a pulse waveform authentication is performed according to the pulse waveform of the living being. Finally, at step S45, a biometrics authentication result is determined according to an object authentication result and a pulse waveform authentication result.

Regarding steps S41 through S45, details of capturing the object images, performing the object authentication, obtaining the pulse waveform, performing the pulse waveform authentication and determining the biometrics authentication result have been described above, thus omitting the redundant descriptions. Further, the biometrics authentication method may comprise step of storing pulse waveform and step of analyzing the wellness of the living being in response to the stored pulse waveform.

In conclusion, the present disclosure provides a biometrics authentication device and a biometrics authentication method, and they have advantages as follows: (1) without adding any new sensor or authentication device, they can perform both an object authentication and a pulse waveform authentication by modifying the firmware of the object scanning device, which increase a security level and decrease a manufacturing cost; (2) the pulse waveform of the living being can be established according to the object images acquired by the object scanning device, and the pulse waveform can be stored and utilized for wellness analysis, which increase an applicability; and (3) the biometrics authentication result is determined according to the object authentication result and the pulse waveform authentication result, which increase a biometrics authentication accuracy.

While the present disclosure has been described by means of specific embodiments, numerous modifications and variations could be made thereto by those skilled in the art without departing from the scope and spirit of the present disclosure set forth in the claims.

What is claimed is:

1. A biometrics authentication device, comprising:
an object scanner, receiving at least one of object images of a living being;
an object authentication device, electrically connected to the object scanner, performing an object authentication according to the at least one object image;
a pulse waveform generation device, receiving the object images to generate a pulse waveform of the living being according to the object images and timestamps at which the object images are captured;
a pulse waveform authentication device, electrically connected to the pulse waveform generation device, performing a pulse waveform authentication device according to the pulse waveform; and
a determination device, electrically connected to the object authentication device and the pulse waveform authentication device, determining a biometrics authentication result according to results of the object waveform authentication and the pulse waveform authentication.

2. The biometrics authentication device according to claim 1, further comprising:
an image capturing device, electrically connected to the object scanner and the pulse waveform generation device, capturing the object images of the living being at the timestamps, respectively.

3. The biometrics authentication device according to claim 1, further comprising:
a storage device, electrically connected to the pulse waveform authentication device, storing the pulse waveform of the living being, wherein the stored pulse waveform of the living being is utilized in a wellness analysis of the living being.

4. The biometrics authentication device according to claim 1, wherein the object scanner extracts an object data from the at least one object image, and the object data relates to an object characteristic data in at least one of a spatial domain and a frequency domain.

5. The biometrics authentication device according to claim 4, wherein the object data is compared with at least one reference object data to perform the object authentication, and the reference object data corresponds to a type of the object data and relates to an object characteristic data in at least one of the spatial domain and the frequency domain.

6. The biometrics authentication device according to claim 1, wherein the pulse waveform generation device obtains a summate value of values of selected pixels in each of the object images and establishes the pulse waveform according to the summated values of the object images and the timestamps.

7. The biometrics authentication device according to claim 6, wherein the selected pixels in each of the object images are determined in a way to maximize a signal-to-noise ratio (SNR) of the pulse waveform.

8. The biometrics authentication device according to claim 1, wherein a pulse waveform characteristic data of the pulse waveform in at least one of a time domain and a frequency domain is compared with at least one reference pulse waveform characteristic data of at least one reference pulse waveform in at least one of the time domain and the frequency domain, to perform the pulse waveform authentication.

9. The biometrics authentication device according to claim 1, wherein the results of the object waveform authentication and the pulse waveform authentication are input to a logic or weighting calculation to determine the biometrics result.

10. The biometrics authentication device according to claim 1, wherein by a firmware of an object scanning device, a processing unit of the scanning device is configured to the object scanner, the object authentication device, the pulse waveform generation device, the pulse waveform authentication device and the determination device.

11. A biometrics authentication method, comprising:
receiving at least one of object images of a living being;
performing an object authentication according to the at least one object image;
receiving the object images to generate a pulse waveform of the living being according to the object images and timestamps at which the object images are captured;
performing a pulse waveform authentication device according to the pulse waveform; and
determining a biometrics authentication result according to results of the object waveform authentication and the pulse waveform authentication.

12. The biometrics authentication method according to claim 11, further comprising:
capturing the object images of the living being at the timestamps, respectively.

13. The biometrics authentication method according to claim 11, further comprising:
storing the pulse waveform of the living being, wherein the stored pulse waveform of the living being is utilized in a wellness analysis of the living being.

14. The biometrics authentication method according to claim 11, an object data is extracted from the at least one object image, and the object data relates to an object characteristic data in at least one of a spatial domain and a frequency domain.

15. The biometrics authentication method according to claim 14, wherein the object data is compared with at least one reference object data to perform the object authentication, and the reference object data corresponds to a type of the object data and relates to an object characteristic data in at least one of the spatial domain and the frequency domain.

16. The biometrics authentication method according to claim 11, a summate value of values of selected pixels in each of the object images is obtained, and the pulse waveform are established according to the summated values of the object images and the timestamps.

17. The biometrics authentication method according to claim 16, wherein the selected pixels in each of the object images are determined in a way to maximize a signal-to-noise ratio (SNR) of the pulse waveform.

18. The biometrics authentication method according to claim 11, wherein a pulse waveform characteristic data of the pulse waveform in at least one of a time domain and a frequency domain is compared with at least one reference pulse waveform characteristic data of at least one reference pulse waveform in at least one of the time domain and the frequency domain, to perform the pulse waveform authentication.

19. The biometrics authentication method according to claim 11, wherein the results of the object waveform authentication and the pulse waveform authentication are input to a logic or weighting calculation to determine the biometrics result.

20. The biometrics authentication method according to claim 11, wherein the biometrics authentication method is implemented by a computing device by executing a software comprising codes.
